(19) United States
(12) Patent Application Publication
(10) Pub. No.: US 2006/0016305 A1
(43) Pub. Date: Jan. 26, 2006

(54) Apparatus for trimming a work piece

(76) Inventor: James F. Urmson, Eustis, FL (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/897,187

(22) Filed: Jul. 22, 2004

(51) Int. Cl. B26D 1/00; B26D 5/08

(52) U.S. Cl. 83/13; 83/581

(57) ABSTRACT

An apparatus for cutting a work piece is provided that may include a frame, a cutting tool, means mounted to the frame for reciprocally translating the cutting tool between a first position and a second position to define a cutting path and means for positioning the work piece with respect to the cutting path so the cutting tool simultaneously makes a first bevel cut and a second bevel cut across an end portion of the work piece when translated from the first position to the second position. The cutting tool may comprise a V-shaped cutting groove.

### FIELD OF THE INVENTION

This invention relates in general to automated machinery for cutting work pieces and in particular to an apparatus for automatically trimming an end portion of a piece of lumber to a predetermined angle that may be used as a member in a roof truss.

### BACKGROUND OF THE INVENTION

Automated sawing machines and systems are well known and available for a wide range of applications. For example, there are many types of computer-controlled sawing systems that cut lumber into prescribed lengths and at various angles according to a cut list programmed or entered into the computer. Many wood structures are fabricated from components that are cut to various lengths using automated sawing machines with each component's end portions being cut at various angles. This allows for two or more components to be more easily joined together where they intersect with one another at different angles. For example, the web and chord components of wooden trusses are often cut and pre-assembled at a fabrication facility then transported to a construction site for roof structures. Other examples are known in the art.

Various sawing apparatuses are disclosed in U.S. Pat. No. 4,098,310 to Sanford et al., U.S. Pat. No. 4,100,949 to Carter, U.S. Pat. Nos. 4,454,794 to Thornton and 4,545,274 to Germond for cutting truss members at predetermined lengths and angles. Carter discloses a machine for forming beveled webs that employs a reciprocable board-severing saw and a pair of electric motors for cutting bevels in the ends of the webs. The motors are mounted to a frame that also supports components for performing other cutting operations.

Thornton discloses another apparatus for cutting bevels or compound angles in the end of a truss member. Thornton discloses an apparatus that makes the compound angle cuts by traversing a power-driven circular saw blade in one direction along a linear guide way with the saw blade at a first angle followed by traversing the saw blade in a second direction along the linear guide way at a second angle to produce the second cut. Similar to the device of Carter, the apparatus used for cutting bevels of Thornton are mounted to a frame that also supports components for performing other cutting operations.

It is also known in the art to cut the ends of truss members individually by hand using a power saw to form various angles for joining respective truss members. This is particularly true in those truss-fabricating facilities that are not highly automated but are more labor intensive. Cutting the truss members in this manner is a multi-step process that is prone to human error and may not meet the rate of production requirements desired by the fabrication facility.

### BRIEF SUMMARY OF THE INVENTION

Embodiments of the invention provide a stand-alone, portable apparatus configured for repetitively and accurately cutting the ends of truss members to preset angles. Embodiments allow for an electric motor to be mounted on a carriage for translating the motor between an upper first position and a lower second position with respect to the work piece being cut or trimmed. The carriage may be set at a desired angle so that when the end of a truss member is inserted horizontally within a guide means the carriage angle will equal a desired angle of cut with respect to the end of the truss member. Different types of cutting blades may be attached the motor's shaft such as a pair of router heads mounted to form a V-shaped cutting groove. This allows for cutting bevels in the end of the truss member at the angle defined by the carriage in one cutting pass.

Embodiments of the invention may be automated or computer-controlled so that when an operator inserts an end of a truss member into the housing or frame a first mechanical switch may be activated to initiate a cutting cycle. The guiding means may horizontally guide the truss member toward the first mechanical switch and into a trimming position. A cutting cycle begins with movement of the carriage from the upper first position toward the lower second position. A first proximity switch may detect the carriage in its upper first position. When the carriage moves away from the first proximity switch a means for securing the truss member in the trimming position may be activated. On completing a cut a second proximity switch may be activated indicating the carriage has reached the lower second position. Activation of the second proximity switch may initiate the carriage's translation back to the first position to complete the cutting cycle. On the carriage's return to the upper first position the first proximity switch may be activated to release the securing means so the truss member may be removed from the housing. Testing has shown that the rate at which the ends of truss members are trimmed may increase from about six per minute using known techniques to about fifteen per minute using embodiments of the invention.

### BRIEF DESCRIPTION OF THE DRAWINGS

The invention will be more apparent from the following description in view of the drawings that show:

FIG. 1 is a perspective view of an embodiment of the invention.

FIG. 2 is a partial perspective view of the embodiment of FIG. 1.

FIG. 3 is a side view of the embodiment of FIG. 1 with a portion of a housing broken away.

FIG. 4 is a top view of the embodiment of FIG. 1 with a top housing removed.

FIG. 5 is a perspective view of a truss member having an end cut.

FIG. 6 is a perspective view of a truss member having an end cut.

FIG. 7 is a perspective view of a truss member having an end cut.

### DETAILED DESCRIPTION OF THE INVENTION

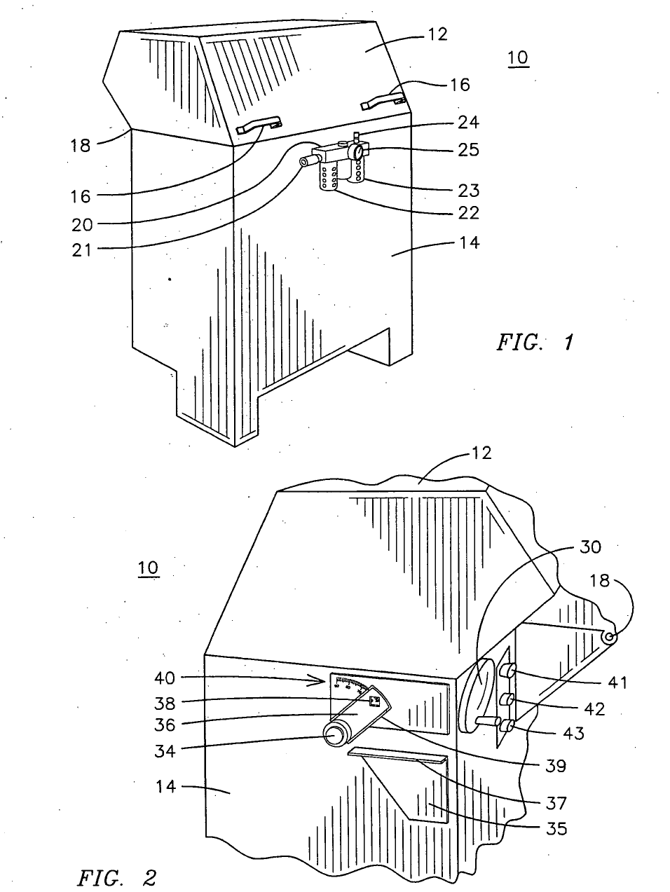

FIG. 1 illustrates an exemplary embodiment of the invention 10 comprising a top housing 12 and a bottom housing or frame 14 both of which may be fabricated of 12-gauge steel with frame 14 encasing an internal support frame 13. A bin (not shown) for catching woodchips may be located beneath frame 14. Handles 16 may be used to lift top housing 12 away from the bottom housing 14 via a hinge 18. A pneumatic regulator or control device 20 may be provided for operating components of the invention as described below. Device 20 may include a connector 21 for receiving an air supply through a connected air supply line (not shown), a water separator 22 for removing water from the air supply and an oiler 23 for supplying oil to a pair of pneumatic valves 64 described below. A connector 24 may be provided for supplying air to valves 64 through an air supply line (not shown) and an air pressure gauge 25 may be used for monitoring air pressure within device 20.

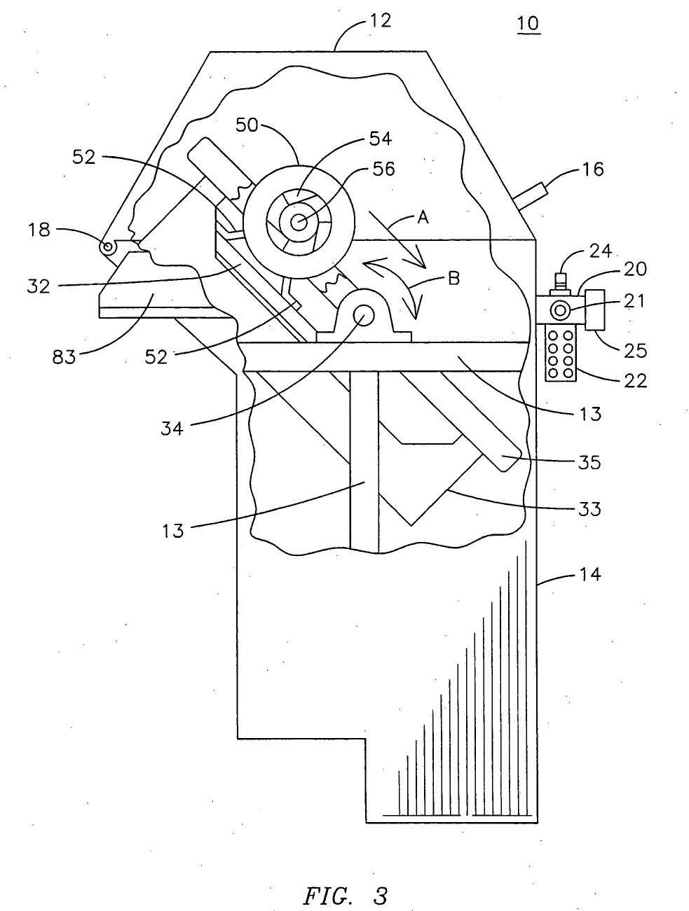

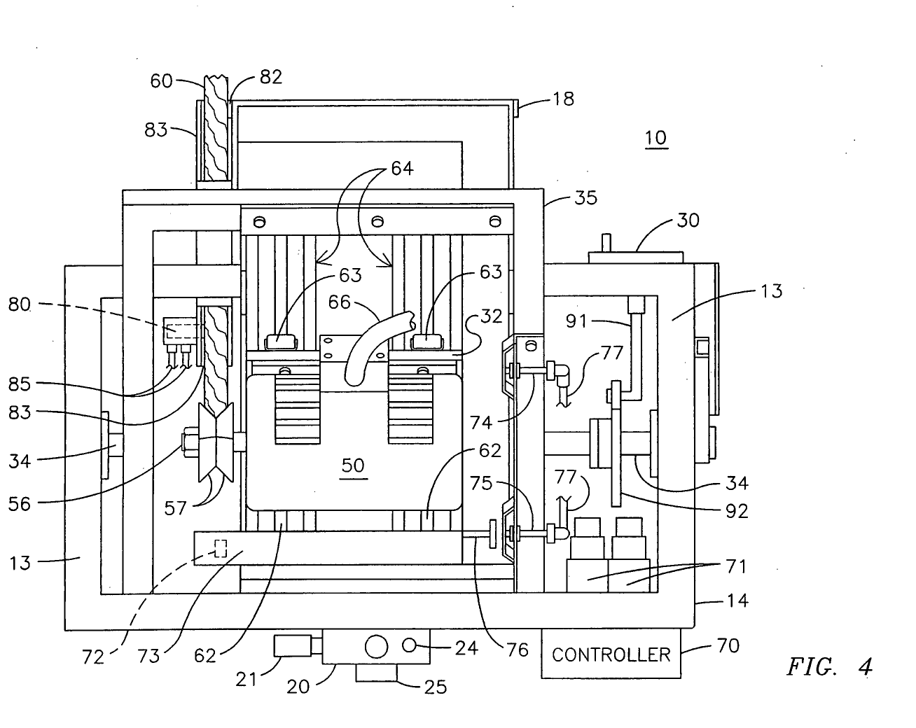

FIG. 2 illustrates a partial view of an exemplary embodiment of the invention comprising a manual turning crank 30 that may be used as part of a means for adjusting the angle of a carriage 32 shown in FIGS. 3 and 4. In an embodiment carriage 32 may be rotatably mounted to frame 14 about a pivot axis 34 so that carriage 32 may be adjusted between horizontal and vertical positions as indicated by arrow B in FIG. 3. In an alternate embodiment the means for adjusting may be computer-controlled such that an operator may enter the desired cut angle into a control processor or the cut angle may be programmed into the processor as part of a cut list. Embodiments of the invention may be used with other computer-controlled cutting machines such as the one disclosed in U.S. Pat. No. 6,615,100, which is incorporated herein by reference in its entirety. An indicator 36 may be provided indicating the carriage's 32 angle with respect to the horizontal. Indicator 36 may have an aperture 38 formed therein so that a scale 40 in degrees is visible to an operator indicating the carriage's 32 angle. This angle may define a cutting path angle as carriage 32 is translated from an upper first position to a lower second position during a cutting cycle.

Referring again to FIG. 2, a guide plate 35 may be affixed to frame 14 and include an upper flange 37 on which a work piece may be placed for an operator to set the cutting path angle. For example, the work piece may be a wooden truss member having an end cut at an angle, as shown in FIG. 5, such as a 45° angle. An operator may set the cutting path angle by ensuring that a lower edge 39 of indicator 36 fits flush against the angled cut when the member is placed on an edge on flange 37. This ensures that the cutting path angle is the same or substantially the same as the angled cut in the end of the work piece. FIG. 2 also illustrates a set of switches that may include a power on switch 41, a power off switch 42 and a manual override switch 43. Switch 43 may allow an operator to manually operate carriage 32 through one cutting cycle. An emergency stop switch (not shown) may also be provided.

FIG. 3 illustrates an exemplary embodiment of the invention with a portion of top housing 12 and bottom housing or frame 14 broken away to show carriage 32. Carriage 32 may be supported within an undercarriage 33 affixed to an upper frame 35. Upper frame 35 may be rotatably mounted within frame 14 about pivot axis 34. The undercarriage 33 and carriage 32 may rotate with upper frame 35 about pivot axis 34, which may comprise a pair of respective steel axels located between outer edges of upper frame 35 and frame 14 as best shown in FIG. 4. In FIG. 3, a portion of upper frame 35 is broken away to show an electric motor 50 that may be attached to carriage 32 such as by support mounts 52, for example, or other appropriate means. Motor 50 may be a 5-HP, 3600-RPM electric motor designated as a NEMA 184T frame. A variable frequency device, such as one commercially available from AC Tech may be used for operating motor 50 at approximately 100 Hz. A cutting tool 54 may be mounted on a shaft 56 of motor 50 and in an embodiment cutting tool 54 may comprise a pair of router blades 57 that are mounted in reverse orientation to form a V-shaped cutting groove. Blades 57 may be conventional stock blades that are approximately 1″ wide, 3-toothed shaper heads for cutting 45° angles. Cutting tool 54 may be used to cut or trim a variety of composite materials and in an embodiment may cut the end portion of a truss member to form a compound angle as more fully described below.

FIG. 4 shows an embodiment of the invention with top housing 12 removed for ease of illustration. Means may be provided for reciprocally controlling the linear movement of the carriage 32 between an upper first position and a lower second position. Carriage 32 may be a support plate on which motor 50 may be mounted. It may be moved or translated within undercarriage 33 by means of guide rails 62 formed on respective ones of a pair of air cylinders 64. Cylinders 64 may have approximately a 10″ run and may be ones commercially available from Rexroth. A pair of carriage guides 63 may matingly engage respective ones of the guide rails 62 for guiding carriage 32 reciprocally along cylinders 64. Cylinders 64 may be actuated through an air hose connection 66, which may interconnect cylinders 64 with pneumatic controller 20. Controller 20 may be interconnected with an appropriately sized compressor.

The means for controlling movement of carriage 32 may include a controller or control processor 70 that actuates a pair of pneumatic valves 71 that drive air cylinders 64. Valves 71 may be ones commercially available from Rexroth that include a single electrical solenoid and may actuate air cylinders 64 in response to a commercially available first mechanical switch 72 being activated. Switch 72 may be depressed and activated by the end of work piece 60, which may be a truss member, when inserted into frame 14 for trimming. Switch 72 may be located on the underside of a bar or bracket 73 that moves or translates in fixed relation with carriage 32 during a cutting cycle. Bracket 73 may rotate with carriage 32 about pivot axis 34 so that the angle of the bracket matches the angled cut in the inserted end of work piece 60. In an embodiment switch 72 may be offset from the center of the inserted end of work piece 60 so that a lateral edge of the end activates switch 72. For example, when carriage 32 is in its upper first position switch 72 may be horizontally aligned with work piece 60 so that when the end of the work piece is inserted within frame 14 a lateral edge of the end will abut switch 72. This activates switch 72 and initiates movement of carriage 32 from the upper first position toward the lower second position. When carriage 32 and bracket 73 move toward the lower second position switch 72 will move off the end of work piece 60 as it moves with carriage 32 thereby releasing the switch.

The means for controlling movement of carriage 32 may include a first inductive proximity switch 74 for detecting the upper first position of carriage 32 and a second inductive proximity switch 75 for detecting the lower second position of carriage 32. First and second positions of carriage 32 may be detected when switches 74, 75 detect a metal flag or indicator 76 that may be affixed to bar 73. These switches may be interconnected with controller 70 via respective connections 77. When a work piece 60 is guided into its trimming position the inserted end may activate switch 72 by pressing the work piece end against the switch. This may signal controller 70 and pneumatic controller 20 through appropriate relays to actuate air cylinders 64, which initiates linear movement of carriage 32 from the upper first position toward the lower second position to perform a cut. Second proximity switch 75 may detect flag 76 when carriage 32 is in the lower second position after the cut is complete as shown in FIG. 4. This may signal controller 70 and pneumatic controller 20 through appropriate relays to actuate air cylinders 64 for returning carriage 32 to the upper first position thereby completing one cutting cycle. First proximity switch 74 may detect flag 76 when carriage 32 is in the upper first position. Controller 70 may be configured so that another cutting cycle is not initiated when switch 74 is detecting flag 76 until switch 72 is again activated or an operator activates a manual override control by depressing override switch 43. Controller 70 may include a 24-volt DC power supply and appropriate breakers. Alternate means for reciprocally controlling linear movement of carriage 32 will be recognized by those skilled in the art and may include electrically or hydraulically driven mechanisms, for example. In alternate embodiments the means for controlling movement of carriage 32 may be computer-controlled rather that switch activated. For example, embodiments of the invention may be used with other computer-controlled cutting machines such as that disclosed in U.S. Pat. No. 6,615,100 whereby the control processor of that cutting machine controls the movement of carriage 32 to complete a cutting cycle.

A means for guiding work piece 60 into a trimming position may be provided. The guiding means may be an appropriately sized channel 82 defined by a metal frame 83 within which work piece 60 may be inserted and horizontally guided within frame 14 so that an end may activate switch 72. The guiding means may be sized to guide an end a wooden truss member having a standard width dimension of approximately 2″ with varying heights of between about 2″ to 6″. The guiding means may be sized so the truss member is standing on an edge when in the trimming position. In this respect, router blades 57 may be sized to accommodate the approximate 2″ width of a truss member 60 to make a pair of compound bevel or other cuts in the end portion. Alternate embodiments allow for different sized and shaped cutting tools 54 to be used for varying sizes of work pieces 60.

In an embodiment of the invention a means for securing work piece 60 in fixed relation to frame 14 when trimming the end may be provided. Referring to FIG. 4, the securing means may be a pneumatically actuated plunger or clamping cylinder 80 mounted to frame 83 that is interconnected with pneumatic controller 20 via connections 85. Cylinder 80 may have approximately a 1″ throw and may be one commercially available from Rexroth. It may be activated when flag 76 moves off of first proximity switch 74 when carriage 32 begins a cutting cycle. When cylinder 80 is actuated it may push work piece 60 against a support surface of frame 83 and secure it in place while a cut is being performed. An end portion of cylinder 80 may have a textured surface for gripping work piece 60 to prevent it from slipping during a cut. When switch 74 detects flag 76 when carriage 32 returns to the upper first position cylinder 80 may be deactivated so work piece 60 may be removed from guide means 82. Alternate means for securing work piece 60 may be used such as ones that are electrically or hydraulically actuated, for example.

As may be appreciated from FIGS. 3 and 4, an embodiment allows for carriage 32 to translate along a linear cutting path or direction indicated by arrow A in FIG. 3. Carriage 32 may translate from an upper first position, which may be above work piece 60 toward a lower second position, which is a position sufficient for cutting tool 54 to traverse a dimension of work piece 60 to complete a cut, such as across a height of work piece 60 positioned within the guiding means. As carriage 32 translates along the cutting path, cutting tool 54 may descend and approach work piece 60 in a direction that is along the work piece's longitudinal or lengthwise axis. Cutting tool 54 may lie in a plane that is coplanar with a plane extending from the upper edge of work piece 60 as shown in FIG. 4. For example, if work piece 60 is a truss member it may be inserted horizontally into the guiding means on an edge as shown in FIG. 4. Carriage 32 may approach the horizontally positioned truss member at an oblique angle to the horizontal so that cutting tool 54 cuts a compound angle toward the end of the truss member that is oblique with respect to the truss member's longitudinal axis. The compound angle may include a first bevel 84 and a second bevel 86 shown in FIG. 5 both of which may be cut in one continuous cutting motion as cutting tool 54 moves simultaneously in an X direction and a Y direction across the end of truss member. In this respect, the cutting path will have a slope of 1 when cutting a 45° angle in the end of work piece 60.

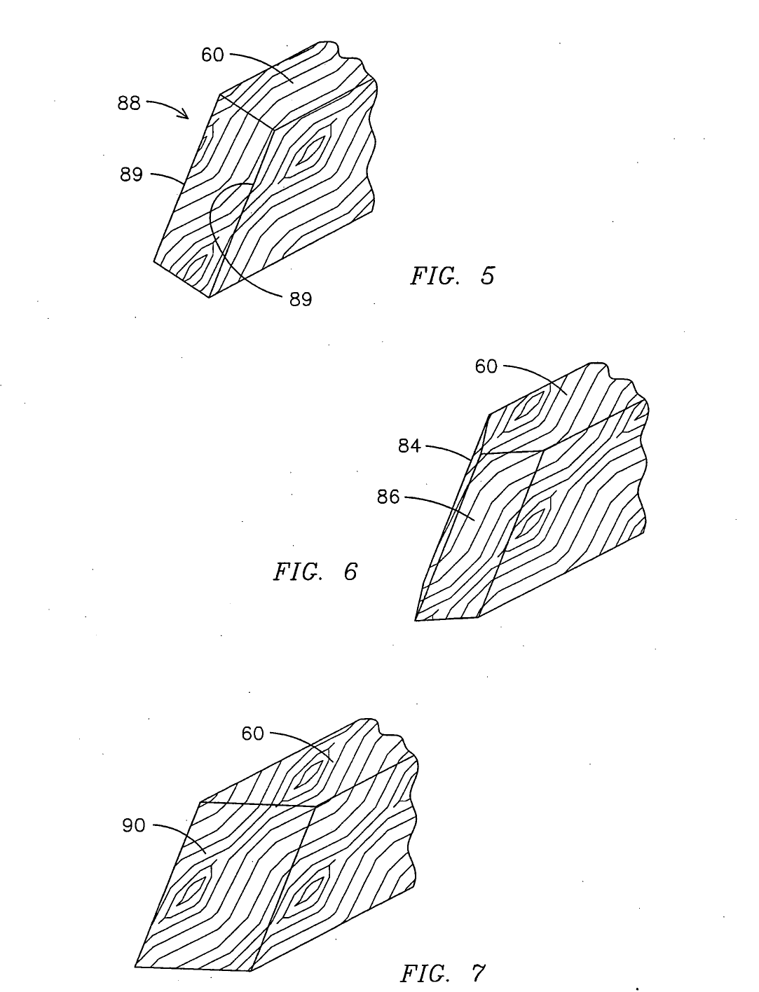

FIG. 5 illustrates an end portion 88 of a truss member 60 having a bevel cut at about a 45° angle across its height. As mentioned above, mechanical switch 72 may be aligned with a portion of a lateral edge 89 of member 60 so that lateral edge 89 depresses switch 72 when member 60 is inserted into frame 14 into a trimming position. As can be appreciated from comparing the cuts shown in FIGS. 5 and 6, the lateral edge 89 is cut away when cutting tool 54 completes its cut thereby releasing switch 72. Offsetting switch 72 from the center of member 60 ensures that switch 72 is not activated again when carriage 32 makes its return run to the upper first position.

The compound angle cut in the work piece 60 or truss member may be at an angle oblique to the length of the truss member such as a 45° angle with respect to the horizontal as shown in FIG. 6. This aspect is advantageous because it allows bevels 84, 86 to be made with an end cut at an oblique angle in one cutting or trimming motion whereas known devices typically make this type of cut with multiple cutting motions and/or movements of the work piece 60. FIG. 7 illustrates that a single bevel 90 may be cut at an oblique angle in the end of a truss member with an appropriately shaped cutting tool 54. It will be appreciated that adjusting the angle of carriage 32 with respect to the horizontal will define the angle of cut or cutting path cutting tool 54 will make as it traverses a dimension of work piece 60 such as the piece's height.

Referring again to FIG. 4, the means for adjusting the angle of carriage 32 may comprise manual turning crank 30 that may be operatively connected via an ACME threaded gear 91 to a coupler 92 connected with shaft or axle 34. Coupler 92 may be an appropriately configured plate responsive to turning crank 30 for correspondingly rotating carriage 32. This allows an operator to adjust the angle of carriage 32 with respect to the horizontal to define the angle at which cutting tool 54 will approach work piece 60 in its trimming position. As carriage 32 changes its angle indicator 36 will correspondingly move to allow an operator to quickly determine the carriage's angle with respect to the horizontal. Alternate means for adjusting the angle of carriage 32 will be recognized by those skilled in the art and may include electrically, pneumatically or hydraulically driven mechanisms, for example, and may be located on the opposite side of frame 14.

While the exemplary embodiments of the present invention have been shown and described by way of example only, numerous variations, changes and substitutions will occur to those of skill in the art without departing from the invention herein. Accordingly, it is intended that the invention be limited only by the spirit and scope of the appended claims.

We claim:

1) An apparatus for cutting a work piece, the apparatus comprising:
a frame;
a cutting tool;
means mounted to the frame for reciprocally translating the cutting tool between a first position and a second position defining a cutting path; and
means for positioning the work piece with respect to the cutting path whereby the cutting tool simultaneously makes a first bevel cut and a second bevel cut across an end portion of the work piece when translated from the first position to the second position.

2) The apparatus of claim 1, the cutting tool comprising a V-shaped cutting groove.

3) The apparatus of claim 1, the means for reciprocally translating comprising:
a carriage mounted with the frame;
a pneumatic drive mechanism interconnected with the carriage;
a pneumatic controller interconnected with the pneumatic drive mechanism; and
a controller to control the carriage in response to activation of a first switch when the work piece is inserted into the frame and into a trimming position.

4) The apparatus of claim 3, the means for guiding comprising a channel formed integral with the frame and sized to guide a work piece having dimensions of approximately two inches wide and four inches high so that the work piece is horizontally disposed on an edge when guided into the frame.

5) The apparatus of claim 4, the cutting tool comprising a V-shaped cutting groove.

6) The apparatus of claim 3 wherein the cutting path is oblique with respect to a longitudinal axis of the work piece.

7) The apparatus of claim 1 further comprising:
means for adjusting the angular orientation of the means for translating with respect to the work piece.

8) An apparatus for trimming an end of a truss member having a length, a height and a width, the apparatus comprising:
a frame;
a carriage mounted to the frame, the carriage rotatable about a pivot axis;
a motor affixed to the carriage;
a cutting tool forming a V-shaped cutting groove mounted to the motor;
means for guiding the truss member into a trimming position; and
means for controlling linear movement of the carriage between an upper first position and a lower second position whereby the cutting tool cuts a compound angle across a dimension of the end of the truss member when moved from the first position to the second position.

9) The apparatus of claim 8 further comprising:
means for adjusting the angle of the carriage.

10) The apparatus of claim 8, the means for controlling linear movement of the carriage comprising:
a controller;
a first mechanical switch positioned with respect to the guiding means so that the end of the truss member activates the first mechanical switch when placed in the trimming position;
a pneumatic drive mechanism operatively coupled with the carriage and responsive to a signal from the controller generated when the first mechanical switch is activated to initiate movement of the carriage from the first position toward the second position; and
a proximity switch positioned proximate the lower second position for initiating movement of the carriage from the lower second position toward the upper first position.

11) The apparatus of claim 10 further comprising:
means for securing the truss member in fixed relation to the frame when in the trimming position; and
a proximity switch proximate the upper first position for actuating the means for securing when the carriage initiates movement from the upper first position toward the second lower position.

12) The apparatus of claim 11, the means for securing comprising a pneumatically actuated plunger responsive to activation of a first proximity switch.

13) The apparatus of claim 8 wherein the carriage is mounted obliquely to the length of the truss member when in the trimming position so that a compound angle is cut at an oblique angle with respect to the length of the truss member when the carriage is moved from the first position to the second position.

14) The apparatus of claim 13 wherein the compound angle forms a first bevel and a second bevel of equal dimension.

15) A cutting apparatus, the apparatus comprising:
a frame;
means for securing a work piece having a width, a height and a length in fixed relation to the frame;
a cutting tool having an axis of rotation that is perpendicular to the height of the work piece; and
means mounted to the frame for reciprocally translating the cutting tool along a cutting path that is coplanar with the width of the work piece and oblique with respect to the length of the work piece whereby the cutting tool cuts a compound angle across the height of the work piece.

16) A method of trimming an end of a truss member, the method comprising:
positioning the truss member in a trimming position; and
translating a cutting tool across an end portion of the truss member to cut a first bevel cut across the height of the truss member in a single cutting motion.

17) The method of claim 16 further comprising:
securing the truss member in fixed relation to a frame; and
controlling the movement of the cutting tool between an upper first position and a lower second position so that a V-shaped cutting groove of the cutting tool simultaneously cuts the first bevel cut and a second bevel cut.

18) The method of claim 16 further comprising:
inserting an end of the truss member into a guide means so the truss member is in the trimming position;
activating a switch to initiate movement of the cutting tool from an upper first position toward a lower second position;
actuating a means for securing the truss member in fixed relation to a frame supporting the cutting tool when the cutting tool initiates movement from the upper first position toward the lower second position;
translating the cutting tool defining a V-shaped cutting groove across an end portion of the truss member to cut the first bevel cut and a second bevel cut across the height of the truss member in a single cutting motion; and
releasing the means for securing when the cutting tool returns to the upper first position after making the first bevel cut and the second bevel cut.
